(19) United States
(12) Patent Application Publication
(10) Pub. No.: US 2003/0026927 A1
(43) Pub. Date: Feb. 6, 2003

(54) Laminate for vacuum cleaner outer bag

(75) Inventors: Girish K. Sharma, Cincinnati, OH (US); Christopher A. Noe, Cincinnati, OH (US); Robert T. Murray, Cincinnati, OH (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 10/174,449

(22) Filed: Jun. 18, 2002

Related U.S. Application Data
(60) Provisional application No. 60/309,030, filed on Jul. 31, 2001.

(51) Int. Cl. B32B 1/02; D04H 1/56; B32B 5/06; B32B 27/04

(52) U.S. Cl. 428/36.1; 442/149; 442/319; 442/389; 442/393; 442/400

(57) ABSTRACT

A uniform, smooth, non-puckering, clothlike, ultrasonic sealing friendly laminate suitable for use as a vacuum cleaner outer bag includes a web of meltblown polymer fibers, with a first nonwoven web formed of staple fibers bonded to one surface of the web of meltblown fibers and with a second nonwoven web formed of staple fibers bonded to the opposite surface of the web of meltblown fibers. The laminate includes an outermost layer of a printed knit textile fabric material laminated to the exposed outer surface of the second nonwoven web.

### CROSS-REFERENCE TO RELATED APPLICATION

This application claims priority from U.S. Provisional Patent Application No. 60/309,030 filed Jul. 31, 2001, the subject matter of which is incorporated herein by reference.

### FIELD OF THE INVENTION

The present invention relates to a fabric laminate, and in particular to a fabric laminate which is suitable for use as a vacuum cleaner outer bag.

### BACKGROUND OF THE INVENTION

In most typical upright vacuum cleaners, the dust and debris which is collected by the vacuum cleaner is deposited in a disposable filter bag housed within an outer dust bag which is suspended from the handle of the vacuum cleaner. This outer bag has a zipper or other closure device to allow for opening the vacuum cleaner outer bag so that the disposable filter bag can be replaced when full. The vacuum cleaner outer bag must be air permeable so that the air that passes through the disposable filter bag can escape from the outer bag. The outer bag is also designed to filter and trap any dust or debris which may have escaped from the inner disposable filter bag and to prevent such dust or debris from being discharged into the room. It is also important for the vacuum cleaner outer bag to be durable and abrasion resistant, in order that it will remain serviceable throughout the useful life of the vacuum cleaner.

Vacuum cleaner outer bags have been manufactured heretofore from various materials, including conventional woven or knitted fabrics as well as laminates including nonwoven materials, as described for example in U.S. Pat. No. 5,244,703.

It is an object of the present invention to provide a fabric laminate which is suitable for use as a vacuum cleaner outer bag, and which provides advantages over the materials presently available for this purpose. More particularly, it is an object of the present invention to provide a fabric laminate which can be fabricated into a vacuum cleaner outer bag and which provides a uniform cloth-like appearance and an excellent combination of strength, abrasion resistance and air permeability.

### SUMMARY OF THE INVENTION

In accordance with the present invention, a fabric laminate is provided which comprises a web of meltblown fibers, with a first nonwoven web of staple fibers bonded to one surface of the web of meltblown fibers, and with a second nonwoven web of staple fibers bonded to the opposite surface of the meltblown fiber web. An outermost layer of a textile fabric material is laminated to the exposed outer surface of the first nonwoven web. In one specific embodiment, the staple fibers of the first and second nonwoven webs, as well as the web of meltblown fibers, comprise polyester fibers, so that the first and second nonwoven webs and the intermediate meltblown web are all formed of the same composition. More preferably, the outermost textile fabric layer is also formed of polyester fibers, such that the entire laminate is of an all polyester construction.

In a more specific embodiment, the first and second nonwoven webs are powder bonded webs of polyester staple fibers. A powder adhesive bonds together the polyester staple fibers of the first and second nonwoven web layers, and also serves to bond these nonwoven web layers to the web of meltblown fibers.

In a further embodiment, the outermost layer of textile fabric comprises a knitted textile fabric. The knitted fabric may be printed, using available textile printing techniques, to provide a decorative pattern and/or printed indicia such as the brand name or other information.

### BRIEF DESCRIPTION OF THE DRAWINGS

Some of the features and advantages of the invention having been stated, others will become apparent from the detailed description which follows, and from the accompanying drawings, in which—

FIG. 1 is a fragmentary perspective view illustrating a fabric laminate in accordance with the present invention; and

FIGS. 2-5 are schematic views illustrating the sequence of process steps utilized in manufacturing the fabric laminate.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

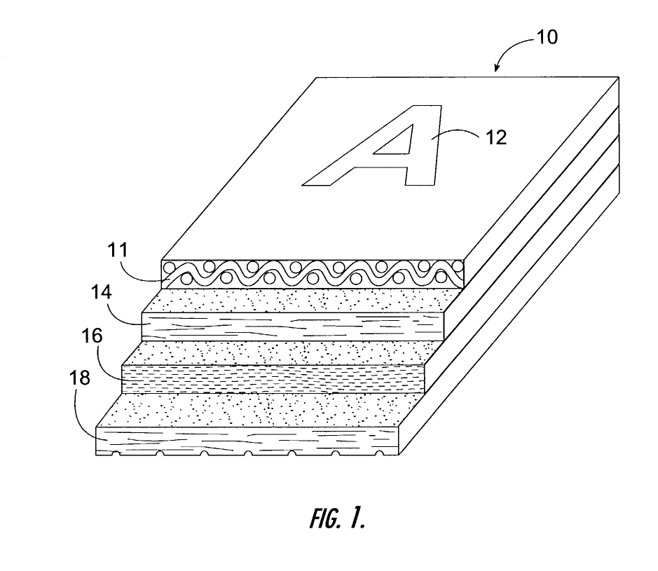

In FIG. 1, one embodiment of the fabric laminate of the present invention is indicated generally by the reference character 10. The outermost surface of the laminate 10, which will be located on the outside of the vacuum cleaner outer bag, is formed by a layer 11 of knitted textile fabric. The yarns of the knitted fabric are preferably formed of polyester fibers, although other synthetic fibers or blends of synthetic and natural fibers could be employed. The outer surface of the knit fabric layer 11 may be imprinted with a decorative design and/or printed indicia 12 as is represented in FIG. 1 by the printed letter A. The knit fabric layer 11 can be printed by any well-known textile printing process, such as transfer printing or screen printing, for example. The knit fabric layer preferably has a basis weight of from about 2 to about 8 ounces per square yard, and more desirably about 3 to 5 ounces per square yard. In other embodiments, the layer 11 can be formed of other kinds of textile fabrics, such as woven or non-woven fabrics. For example, the fabric layer 11 could be a spunlace nonwoven fabric.

The fabric layer 11 is bonded to one exposed surface of a composite nonwoven fabric formed of three distinct nonwoven layers: a first nonwoven web 14 of staple fibers, a web 16 of meltblown fibers and a second nonwoven web 18 of staple fibers which forms the exposed inner surface of the fabric laminate 10. The webs 14, 16, and 18 are bonded to one another to form a composite nonwoven fabric laminate. The knit fabric layer 11 is bonded to the surface of the first nonwoven web 14.

The nonwoven webs 14 and 18 are preferably formed of crimped staple fibers which have been formed into a carded web by a textile carding machine. The staple fibers may be of the same denier, or if desired, fibers of two or more different deniers can be blended together in forming the carded web. The staple fiber nonwoven webs 14 and 18 are preferably formed from fibers within the range of from about 2 to about 6 denier. For example, the webs can be formed from 2.25 denier per filament fibers. In one preferred embodiment the nonwoven webs 14 and 18 are formed of polyester staple fibers. The webs can also be formed from a blend of conventional monocomponent polyester fibers with bicomponent polyester fibers. Sheath-core bicomponent fibers having a higher melting polyester core and a lower melting co-polyester sheath can be blended with conventional monocomponent polyester fibers to serve as binder fibers providing enhanced strength properties to the webs. Alternatively, the nonwoven webs 14 and 18 can be formed of polypropylene staple fibers.

The web 16 of meltblown fibers is produced by the well-known melt-blowing process, as is described for example in Buntin et al. U.S. Pat. No. 3,849,241. Molten polymer, preferably polyester, is extruded from a meltblowing die equipped with a source of high velocity gas, such as air, which impinges upon the freshly extruded molten polymer and attenuates the polymer into fine fibers. The meltblown fibers are carried by the high velocity gas stream and are deposited on a collecting surface to form a web of randomly dispersed meltblown fibers. The web of meltblown fibers preferably has a basis weight of from 0.4 to 2.5 ounces per square yard. In a particularly embodiment, the meltblown web has a basis weight of about 0.6 to 1.0 ounces per square yard. The meltblown web 16 can be formed of any thermoplastic polymer suitable for meltblowing, although in a preferred construction the meltblown web 16 is made from a polyester, such as polyethylene terephthalate or polybutylene terephthalate. The fibers which form the meltblown web 16 are typically much finer than the fibers of the staple fiber webs 14 and 18. The meltblown fibers have an average diameter no greater than about 20 microns, and preferably have a diameter of from less than one micron up to about 10 microns.

The first nonwoven web 14 of staple fibers is preferably formed of polyester staple fibers and preferably has a basis weight of from 0.5 to 3 ounces per square yard. In a preferred embodiment, this nonwoven web is a powder bonded nonwoven web. Powder formed of a potentially adhesive thermoplastic material is deposited onto the nonwoven web and serves to bond the fibers of the nonwoven web to one another to form a coherent strong web. The adhesive powder may, for example, comprise a polyester polymer or copolymer having a lower melting point than the polyester polymer composition from which the fibers are formed.

The second nonwoven web 18 is also preferably formed of polyester staple fibers and preferably has a basis weight of from 1 to 4 ounces per square yard. In a preferred embodiment, the first nonwoven web layer has a basis weight lower than the second nonwoven web. Web 18 is also preferably a powder bonded nonwoven web.

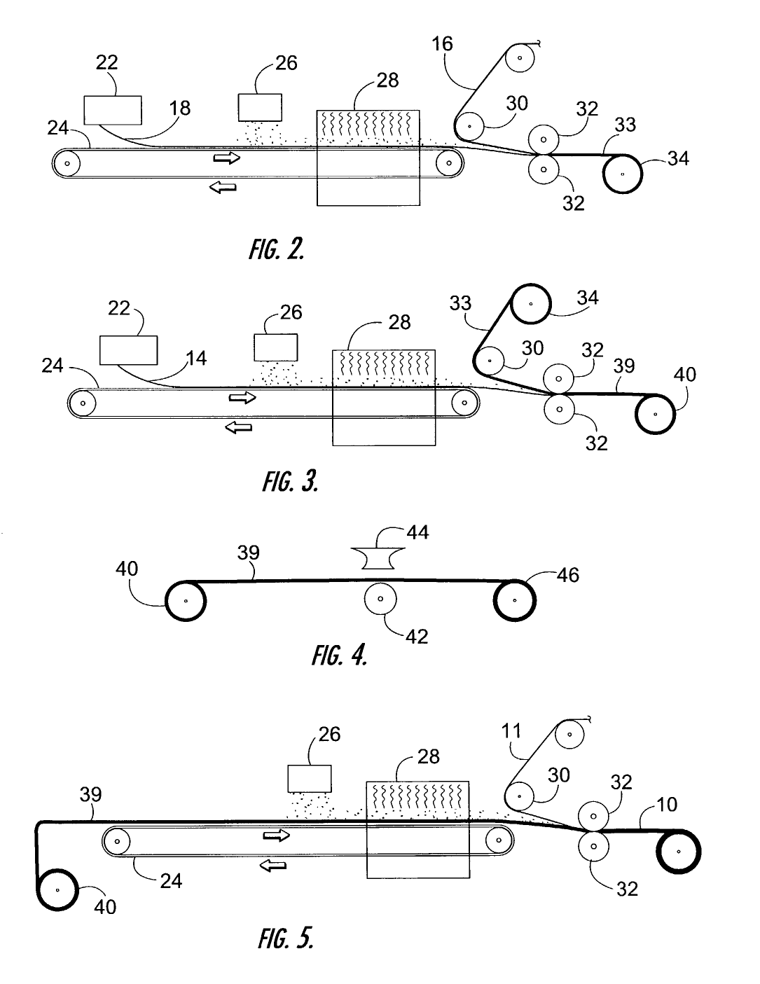

A process and apparatus suitable for producing the fabric laminate of the present invention is shown schematically in FIGS. 2 to 5. As shown in FIG. 2, a carded web of staple fibers is produced by a textile carding machine 22 and is deposited on a moving belt 24. The web is advanced beneath an adhesive applicator station 26 where adhesive powder is deposited onto the web. As the web continues to advance along the moving belt, it is directed through an oven 28 heated to a temperature sufficient for activating the adhesive properties of the adhesive powder. As the heated nonwoven fabric emerges from the oven, a web 16 of meltblown fibers is unrolled from a supply roll and is directed around an idler roller 30 and into contact with one surface of the staple fiber web. The two webs are directed through a laminating nip defined by a pair of cooperating rolls 32, whereupon the staple fiber web is compressed into contact with the meltblown web. The resulting two-layer composite 33 is wound into a roll 34 for further processing.

As shown in FIG. 3, in a subsequent operation, an additional web 14 of staple fibers is formed by the carding machine 22 and is deposited on the moving belt 24. Adhesive powder is deposited onto the web and the web is advanced through the heated oven 28. As the web 14 emerges from the oven 28, the previously formed two layer composite 33 is unwound from roll 34 and is directed around the idler roller 30 so that the meltblown side of the two layer composite is brought and into contact with the upper surface of the staple fiber web 14. The webs are directed through the laminating nip 32, where they are compressed, consolidated, and securely bonded together to form a three layer composite 39, with the meltblown layer 16 in the center and with the first and second nonwoven webs 14 and 18 adhered to opposite sides of the meltblown layer. The composite is wound into a roll 40.

As shown in FIG. 4, the three-layer composite produced as described above is then subjected to ultrasonic lamination. The three-layer composite material 39 is unrolled from the roll 40 and directed between a patterned embossing roller 42 and an ultrasonic horn 44. The patterned embossing roller 42 has a suitable pattern engraved therein for imparting an embossed configuration to the composite. For example, the embossed pattern may resemble a dot pattern. In the preferred embodiment shown, the composite is directed through the laminating station with the heavier basis weight staple fiber web facing the embossing roller and with the lighter basis weight web facing the ultrasonic horn. As a result, the surface of the heavier web 18 has a pattern embossed therein. The three layer laminate is wound into a roll 46 for further processing. In the final step, shown in FIG. 5, the printed knit fabric 11 is laminated to the surface of the lighter basis weight web 14. As shown, the embossed three-layer composite nonwoven fabric 39 is unrolled from the supply roll 46 and advanced along the moving belt 24 past the adhesive applicator 26 where adhesive powder is deposited onto the underlying composite. The composite is oriented with the lighter basis weight web 14 facing upwardly for receiving the adhesive powder. After passing through the oven to activate the adhesive powder, the printed knit fabric 11 is directed around the idler roller and into contact with the exposed surface of the staple fiber web. The layers are directed through the laminating nip 32 whereupon the knitted fabric is firmly and permanently bonded to the nonwoven composite fabric.

The fabric laminate 10 of the present invention has a uniform, smooth, non-puckering surface, with a clothlike appearance. It can be advantageously fabricated into a bag using commercially available sewing, ultrasonic sealing or heat-sealing equipment. The all-polyester construction makes it resistant to high temperatures, yet readily sealable to itself or to other components such as straps or buckles, using ultrasonic or other sealing means. The ultrasonic pattern bonding makes the laminate more resistant to delaminating, enhances flexibility, prevents puckering, and imparts an aesthetically pleasing patterned appearance to the nonwoven surface of the laminate, The invention will be further understood from the following illustrative, nonlimiting example.

### EXAMPLE 1

A laminate 10 of the construction shown in FIG. 1 was produced generally in accordance with the process described above and illustrated in FIGS. 2 to 5. The respective layers of the laminate were as follows:

11 Printed polyester jersey knit fabric 3.3 ounces per square yard.

14 1 ounce per square yard powder bonded web of carded polyester staple fibers. The web comprised 55% by weight 2.25 denier per filament polyester staple fibers, 14% by weight 4 denier per filament sheath/core bicomponent polyester staple fibers (co-polyester sheath—polyester homopolymer core) and 31% by weight polyester copolymer adhesive powder (m.p. 250° F.).

16 0.8 ounce per square yard web of meltblown polyester fibers of 1 to 10 micron fiber diameter.

18 2 ounce per square yard powder bonded web of carded polyester staple fibers (a blend of 66% by weight 2.25 denier polyester, 16% by weight 4 denier per filament polyester bicomponent (copolyester sheath with polyester core), and 18% polyester copolymer powder adhesive (m.p. 250° F.).

The fabric laminate 10 exhibited a smooth, uniform non-puckered clothlike appearance: The nominal basis weight was 7.0 ounces per square yard, the nominal thickness was 25 to 30 mil; and the nominal Frazier air permeability was 30-35 cfm/sq.ft. The composite fabric laminate was fabricated into a vacuum cleaner outer bag.

### EXAMPLE 2

A laminate 10 was produced as in Example, 1, but with the following layers:

11 Printed polyester jersey knit fabric 3.3 ounces per square yard.

14 1 ounce per square yard powder bonded web of carded polyester staple fibers. The web comprised 55% by weight (18 grams 4 denier per filament white polyester staple fibers, 14% by weight (4.5 grams) 2¼ denier per filament black/gray sheath/core bicomponent polyester staple fibers (co-polyester sheath—polyester homopolymer core) and 31% by weight (10 grams) polyester copolymer adhesive powder (m.p. 250° F.).

16 0.8 ounce per square yard web of black/gray meltblown polyester fibers of 1 to 10 micron fiber diameter.

18 2 ounce per square yard powder bonded web of carded polyester staple fibers (a blend of 41% by weight (23½ grams) 4 denier per filament white polyester staple fibers, 41% by weight (23½ grams) 2¼ denier per filament black/gray sheath/core polyester bicomponent staple fibers (copolyester sheath with polyester core), and 18% polyester (10 grams) copolymer powder adhesive (m.p. 250° F.).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A laminate suitable for use as a vacuum cleaner outer bag, said laminate comprising:
a web of meltblown fibers,
a first nonwoven web formed of staple fibers bonded to one surface of said web of meltblown fibers,
a second nonwoven web formed of staple fibers bonded to the opposite surface of said web of meltblown fibers, and
an outermost layer of a textile fabric material laminated to the exposed outer surface of said second nonwoven web.

2. A laminate according to claim 1, wherein said web of meltblown fibers comprises meltblown polyester fibers.

3. A laminate according to claim 1, wherein said first and second nonwoven webs are formed of polyester staple fibers.

4. A laminate according to claim 1, wherein said first and second nonwoven webs are formed of polypropylene staple fibers.

5. A laminate according to claim 4, wherein said web of meltblown fibers comprises meltblown polypropylene fibers.

6. A laminate according to claim 1, including a powder adhesive bonding together the staple fibers of said first nonwoven web layer and also serving to bond said first nonwoven web layer to said web of meltblown fibers.

7. A laminate according to claim 6, also including a powder adhesive bonding together the staple fibers of said second nonwoven web layer and also serving to bond said second nonwoven web layer to said web of meltblown fibers.

8. A laminate according to claim 7, also including a powder adhesive disposed between and bonding together said outer exposed surface of said second nonwoven web layer and said outermost layer of textile fabric.

9. A laminate according to claim 1, wherein said outermost layer of textile fabric comprises a knitted textile fabric having a printed outer surface.

10. A laminate according to claim 9, wherein the exposed outer surface of said first nonwoven web layer is embossed.

11. A laminate according to claim 1, wherein said outermost layer of textile fabric comprises a spunlace nonwoven fabric.

12. A laminate suitable for use as a vacuum cleaner outer bag, said laminate comprising:
a web of meltblown polyester fibers,
a first nonwoven web layer formed of polyester staple fibers bonded to one surface of said web of meltblown fibers,
a powder adhesive provided in said first nonwoven web layer bonding together the polyester staple fibers thereof and also serving to bond said first nonwoven web layer to said web of meltblown fibers,
a second nonwoven web layer formed of polyester staple fibers bonded to the opposite surface of said web of meltblown fibers,
a powder adhesive provided in said second nonwoven web layer bonding together the polyester staple fibers thereof and also serving to bond said second nonwoven web layer to said web of meltblown fibers, and
an outermost layer of a knit textile fabric material laminated to the exposed outer surface of said second nonwoven web layer.

13. A laminate according to claim 12, wherein said powder adhesive in said first and second nonwoven web layers is a polyester powder adhesive, and also including a polyester powder adhesive disposed between said outermost layer of knit textile fabric and said outer surface of said second nonwoven web layer and bonding the layers together.

14. A laminate suitable for use as a vacuum cleaner outer bag, said laminate comprising:
a web of meltblown polymer fibers,
a first nonwoven web layer formed of polypropylene staple fibers bonded to one surface of said web of meltblown fibers,
a powder adhesive provided in said first nonwoven web layer bonding together the staple fibers thereof and also serving to bond said first nonwoven web layer to said web of meltblown fibers,
a second nonwoven web layer formed of polypropylene staple fibers bonded to the opposite surface of said web of meltblown fibers,
a powder adhesive provided in said second nonwoven web layer bonding together the staple fibers thereof and also serving to bond said second nonwoven web layer to said web of meltblown fibers, and
an outermost layer of a nonwoven textile fabric material laminated to the exposed outer surface of said second nonwoven web layer.

15. A laminate suitable for use as a vacuum cleaner outer bag, said laminate comprising:
a multiplicity of meltblown polyester fibers bonded to one another to form a meltblown web having a basis weight of from 0.4 to 2.5 ounces per square yard,
a first powder bonded nonwoven web layer formed of polyester staple fibers bonded to one surface of said web of meltblown fibers, said first powder bonded nonwoven web layer having a basis weight of from 0.5 to 3 ounces per square yard,
a second powder bonded nonwoven web layer formed of polyester staple fibers bonded to the opposite surface of said web of meltblown fibers, said second powder bonded nonwoven web layer having a basis weight of from 1 to 4 ounces per square yard,
a pattern of ultrasonic lamination points bonding said first and second nonwoven webs to said web of meltblown polyester fibers and also serving to impart an embossed pattern to the outer exposed surface of said first nonwoven web layer, and
an outermost layer of a knit textile fabric laminated to the outer exposed surface of said second nonwoven web layer.

16. A laminate according to claim 15, wherein said meltblown web has a basis weight of from 0.5 to 1 ounces per square yard, said first nonwoven web layer has a basis weight of from 0.5 to 1.5 ounce per square yard, and said second nonwoven web layer has a basis weight of from 1.0 to 3 ounces per square yard.

17. A laminate according to claim 16 wherein said second nonwoven web layer has a basis weight greater than said first nonwoven web layer.

18. A laminate according to claim 15, wherein said first and second nonwoven web layers are comprised of a blend of monocomponent polyester fibers and bicomponent polyester fibers.

19. A vacuum cleaner outer bag formed from the laminate of claim 1.

20. A vacuum cleaner outer bag formed from the laminate of claim 12.

21. A vacuum cleaner outer bag formed from the laminate of claim 15.

22. A process for producing a laminate suitable for use as a vacuum cleaner outer bag, said process comprising
forming a first nonwoven web layer from staple fibers,
bonding one surface of said nonwoven web layer to one surface of a web of meltblown fibers,
forming a second nonwoven web layer from staple fibers,
bonding one surface of said second nonwoven web layer to the opposite surface of said web of meltblown fibers, and
bonding the exposed outer surface of said second nonwoven web layer to a textile fabric material.

23. A process according to claim 22, wherein said step of forming a first nonwoven web layer and said step performing a second nonwoven web layer each comprise carding polyester staple fibers and forming therefrom a carded nonwoven web.

24. A process according to claim 22, wherein said step of bonding one surface of said nonwoven web layer to one surface of a web of meltblown fibers comprises distributing a powder adhesive onto said first nonwoven web layer, directing the nonwoven web layer and the powder adhesive through an oven and heating the powder adhesive to render it adhesive, directing a web of meltblown fibers into contact with said one surface of said nonwoven web layer, and directing the first nonwoven web layer and the meltblown web of through a laminating nip and applying pressure to bond the nonwoven web layer to the meltblown web.

25. A process for producing a laminate suitable for use as a vacuum cleaner outer bag, said process comprising
forming a first carded nonwoven web of polyester staple fibers,
distributing a powder adhesive onto the first carded nonwoven web,
directing the first carded nonwoven web and the powder adhesive through an oven and heating the powder adhesive to render it adhesive,
directing a web of meltblown fibers into contact with one surface of said first carded nonwoven web and directing the thus-assembled webs through a laminating nip and applying pressure to bond the nonwoven web carded web to the meltblown web.
forming a second carded nonwoven web of polyester staple fibers, distributing a powder adhesive onto the second carded nonwoven web,
directing the second carded nonwoven web and the powder adhesive through an oven and heating the powder adhesive to render it adhesive,
directing the exposed surface of said web of meltblown fibers into contact with one surface of said second carded nonwoven web and directing the thus-assembled webs through a laminating nip and applying pressure to bond the webs together to form a composite nonwoven laminate, and
bonding a textile knit fabric material to the exposed outer surface of said second nonwoven web layer of said composite nonwoven laminate.

26. A process according to claim 25, including the step of forming a pattern of ultrasonic bonds in the composite nonwoven laminate prior to bonding to the textile knit fabric material.

27. A process according to claim 25, wherein the step of bonding a textile knit fabric material to said composite nonwoven laminate comprises bonding the knit fabric material to the composite nonwoven laminate using a powder adhesive.
